(19) United States
(12) Patent Application Publication
(10) Pub. No.: US 2021/0225606 A1
(43) Pub. Date: Jul. 22, 2021

(54) LEAKAGE CURRENT PROTECTION DEVICE EMPLOYING A PIVOTING ACTUATOR IN THE TRIP ASSEMBLY

(71) Applicant: Chengli LI, Suzhou (CN)

(72) Inventors: Chengli LI, Suzhou (CN); Xiaoming ZHANG, Suzhou (CN); Shengyun NIE, Suzhou (CN)

(73) Assignee: Chengli LI, Suzhou (CN)

(21) Appl. No.: 16/789,283

(22) Filed: Feb. 12, 2020

(30) Foreign Application Priority Data
Jan. 16, 2020 (CN) 202010046288.1
Jan. 16, 2020 (CN) 202020091363.1

(51) Int. Cl. H01H 71/24; H01H 71/32; H01H 71/12; H01H 71/52; H01H 83/04; H01H 83/20; H01H 73/44; H01H 73/20; H01H 73/08; H02H 3/16

(52) U.S. Cl. CPC H01H 71/2463; H01H 71/322; H01H 71/128; H01H 71/52; H01H 71/125; H01H 2083/203; H01H 83/20; H01H 73/44; H01H 73/20; H01H 73/08; H02H 3/16; H01H 83/04

(57) ABSTRACT

A leakage current protection device includes a shell and a core assembly disposed within the shell. The core assembly includes a control circuit board, a trip assembly disposed on the control circuit board, and an input end and an output end connected to the trip assembly. The trip assembly includes a first driving member movable linearly in a first direction and a second driving member pivotable around a pivotal support axis, where the first and second driving members are mechanically engaged with each other and move together with each other. The second driving member has two driving points configured to move in a second direction as the second driving member pivots, the second direction being non-parallel to the first direction. Movements of the two driving points of the second driving member in the second direction are operable to electrically connect or disconnect the input and output ends.

### BACKGROUND OF THE INVENTION

### Field of the Invention

This invention relates generally to electrical appliances, and in particular, it relates to a leakage current protection device for electrical appliance.

### Description of Related Art

With the increased safety awareness relating to electrical appliances, leakage current protection devices are more widely used. There are also increased performance requirements for leakage current protection devices, such as higher power, lower temperature rise, smaller size, increased reliability, etc. These facture influence the design of leakage current protection devices.

### SUMMARY

The present invention is directed to leakage current protection devices that meet higher performance requirements with increased safety for users.

To achieve the above objects, the present invention provides a leakage current protection device, which includes: a shell; and a core assembly disposed within the shell, wherein the core assembly includes a control circuit board, a trip assembly disposed on the control circuit board, and an input end and an output end connected to the trip assembly; wherein the trip assembly includes a first driving member movable linearly in a first direction and a second driving member pivotable around a pivotal support axis, wherein the first driving member and the second driving member are mechanically engaged with each other and move together with each other, wherein the second driving member has two driving points configured to move in a second direction as the second driving member pivots, the second direction being non-parallel to the first direction, and wherein movements of the two driving points of the second driving member in the second direction are operable to electrically connect or disconnect the input end and the output end.

Based on the above design, the invention may include one or more of the following features.

In some embodiments, the trip assembly further includes a relay coil, wherein the first driving member is a plunger disposed inside the relay coil, and the second driving member is a trip actuator, wherein when the plunger is in its first position, the trip actuator is in its first position which electrically disconnects the input end and output end, and when the plunger is actuated by the relay coil and moves to its second position, the trip actuator moves accordingly to its second position which electrically connects the input end and output end.

In some embodiments, one of the trip actuator and the plunger has a slot and the other one of the trip actuator and the plunger has a corresponding portion that fits in the slot.

In some embodiments, the trip assembly further includes a magnetically permeable device configured to cooperate with the relay coil, the magnetically permeable device includes a magnetic core disposed inside the relay coil, a magnetic frame, and a magnetic plate, wherein the magnetic frame and the magnetic plate are disposed around the relay coil.

In some embodiments, the trip assembly further includes a trip frame, wherein the trip actuator has two pivotal support posts and the trip frame has two corresponding position limiting indentations configured to respectively accommodate the two pivotal support posts, wherein the trip actuator is pivotable around an axis defined by the two pivotal support posts.

In some embodiments, the input end includes a pair of insertion plates, each insertion plate including a stationary contact terminal, wherein the output end includes a pair of resilient contact arms, each resilient contact arm having a moveable contact terminal configured to cooperate with the corresponding stationary contact terminal, and wherein the two driving points of the trip actuator press the moveable contact terminals to contact the corresponding stationary contact terminals.

In some embodiments, the trip frame includes two position limiting slots, wherein the pair of resilient contact arms respectively pass through the two position limiting slots. In some embodiments, the core assembly further includes a detector assembly, and a wiring assembly that passes through the detector assembly, wherein the pair of resilient contact arms are electrically connected to the output end via the wiring assembly.

In some embodiments, the leakage current protection device of further includes: a reset button and a reset conductor embedded in the reset button; a test button and a test conductor embedded in the test button; wherein the reset button and the test button protrude from the shell, and wherein the reset conductor is configured to contact the control circuit board in response to the reset button being depressed, and the test conductor is configured to contact the control circuit board in response to the test button being depressed.

In some embodiments, the reset button and the test button are formed of a flexible insulating material, and the reset conductor and the test conductor are elastically embedded in the reset button and the test button, respectively.

In some embodiments, the leakage current protection device further includes a cable strain relief connected to the shell and extends outside of the shell, and an affixing assembly configured to affix electrical output wires to the shell.

In the embodiment, the trip actuator that causes the electrical connection and disconnection is a component that pivot around an axis. While providing safety protection, this design reduces the size of the leakage current protection device, reduces cost, and reduces manufacturing complexity.

### BRIEF DESCRIPTION OF THE DRAWINGS

Characteristics and advantages of the present invention may be understood from the detailed descriptions below with reference to the following drawings.

FIG. 1 is an external view of a leakage current protection device according to an embodiment of the present invention.

FIG. 2 is an exploded view of the leakage current protection device.

FIG. 3 is an exploded view of a core assembly of the leakage current protection device.

FIG. 4 is a side view of the core assembly.

FIG. 5 is an exploded view of a part of a trip assembly of the leakage current protection device.

FIG. 6 is a cross-sectional view of the leakage current protection device in a disconnected state (first state).

FIG. 7 is a perspective view of the core assembly of the leakage current protection device in a disconnected state (first state).

FIG. 8 is a cross-sectional view of the leakage current protection device in a connected state (second state).

FIG. 9 is a perspective view of the core assembly of the leakage current protection device in a connected state (second state).

FIG. 10 is a circuit diagram of the leakage current protection device according to an embodiment of the present invention.

### DETAILED DESCRIPTION OF PREFERRED EMBODIMENTS

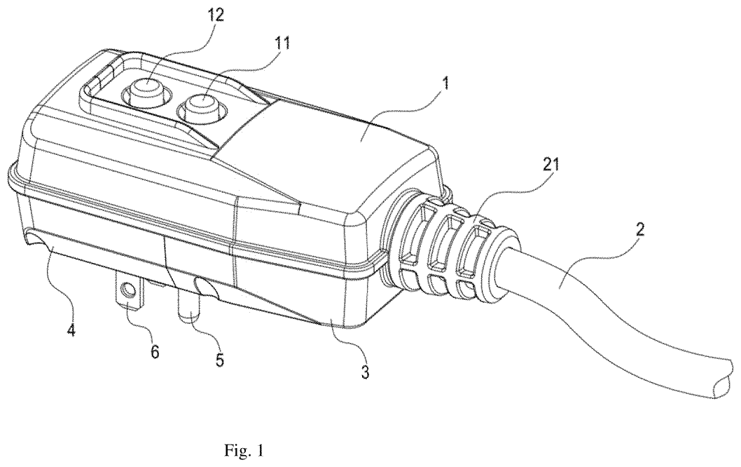

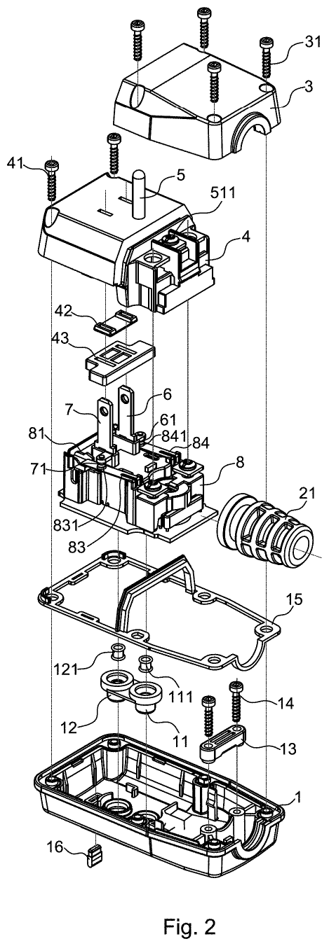

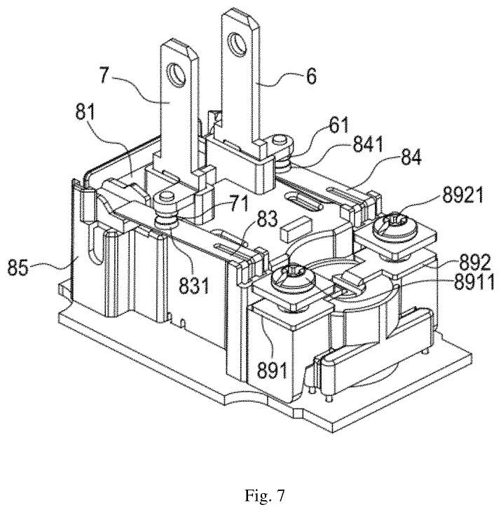

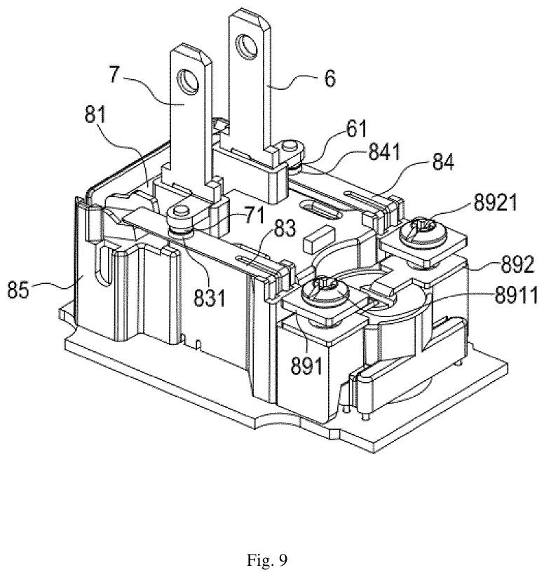

Preferred embodiments of the present and their applications are described below. It should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change. Note that FIGS. 1, 4, 6, and 8 are in an orientation where the prongs point downwards, while FIGS. 2, 3, 5, 7, and 9 are in an orientation where the prongs point upwards.

FIGS. 1 and 2 illustrate a leakage current protection device according to an embodiment of the present invention. In this embodiment, an electrical plug is used as an example, but it should be understood that the invention may alternatively be embodied in other electrical devices.

In this embodiment, the leakage current protection device includes a shell, a core assembly 8 disposed in the shell, which is configured to electrically connect or disconnect the input end and the output end, and a cable strain relief 21 connected to the shell and extends outside of the shell, which is configured to provide waterproof and bend-resistance of the cable. An output electrical cable 2 is electrically connected to the leakage current protection device via the cable strain relief 21. The shell includes a top cover 1, a back cover 3 and a base cover 4, which are fastened to each other by multiple fasteners (such as screws 31 and 41). In alternative embodiments, the back cover 3 and base cover 4 may be an integral piece. The top cover 1 is provided with openings for a reset button 12 (RESET) and a test button 11 (TEST) to extend out of the shell. The reset button 12 and test button 11 may be made of a flexible insulating material, such as rubber. The reset button 12 and test button 11 may be formed as an integral piece, as shown in FIG. 2, or formed as separate pieces. A reset conductor 121 and a test conductor 111 are respectively elastically embedded in the reset button 12 and the test button 11, and respectively function to reset the leakage current protection device and to test whether the device is functioning properly.

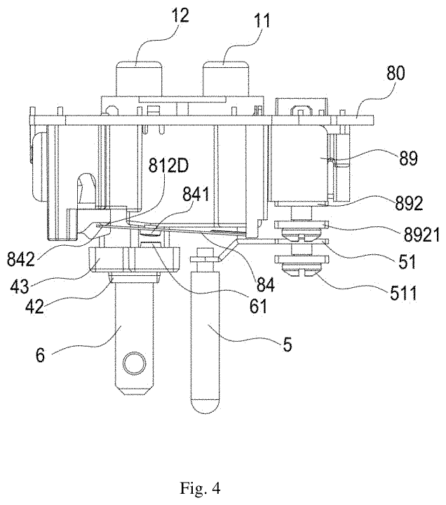

In the leakage current protection device, the electrical input end includes a pair of contact arms or other suitable electrical coupling structures, such as line (L) insertion plate (prong) 7 and neutral (N) insertion plate (prong) 6, which may extend out of the shell from openings on the base cover 4. Each insertion plate has a stationary contact terminal, such as a line stationary contact terminal 71 and a neutral stationary contact terminal 61. Correspondingly, the output end includes a pair of resilient contact arms, such as a line resilient contact arm 83 and a neutral resilient contact arm 84. The line and neutral resilient contact arms 83 and 84 have respective moveable contact terminals, such as a line moveable contact terminal 831 and a neutral moveable contact terminal 841, which cooperate with the corresponding line and neutral stationary contact terminals to form electrical switches. Preferably, a ground insertion plate (prong) 5 and a ground conductor plate 51 (see FIG. 4) may be pressed together with the base cover 4. A ground wiring screw assembly 511 is disposed on the ground conductor plate 51 and used to connect the input and output ground wires.

As shown in FIG. 2, in some embodiment, waterproof components are provided between the various covers of the shell and between the cover and the insertion plates, so that the device is suitable for use in damp or wet environments. Preferably, the waterproof components include a shell waterproof seal 15 disposed between the top cover 1 and the back cover 3 and base cover 4, as well as an insertion plate waterproof seal 42 disposed between the insertion plates and the core assembly. Each waterproof seal is shaped to mate with the components that it is in contact with. Further, in some embodiments, the top cover 1 is provided with an affixing assembly for affixing the electrical output wires to the shell, such as a wire clamp board 13 and clamp board screws 14, to prevent the electrical output wires from becoming loose or moving. In some embodiments, the top cover 1 may further include a light conducting piece 16 for transmitting light generated by an LED indicator on the core assembly 8 to the surface of the shell.

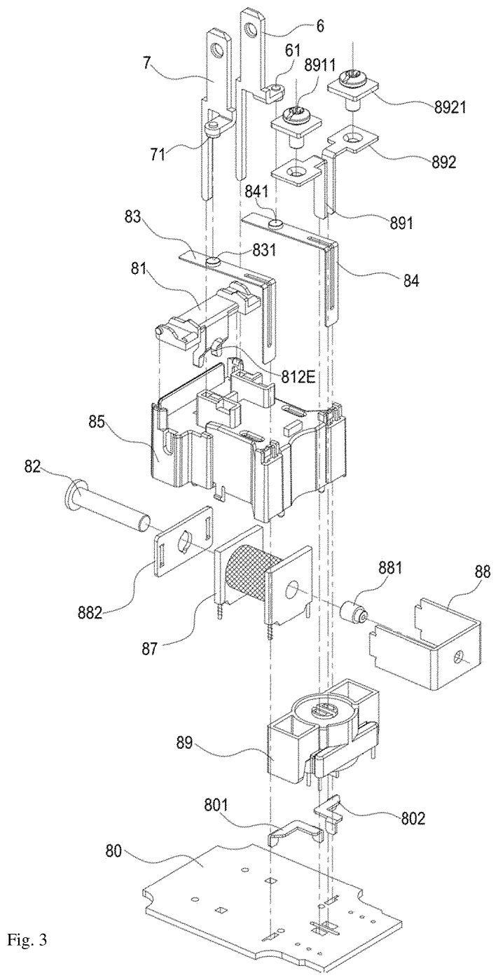

The core assembly 8 of the leakage current protection device is described in more detail below. As shown in FIGS. 3-5, the core assembly 8 includes a control circuit board PCBA 80, and a trip assembly and a detection assembly disposed on the PCBA 80. The neutral insertion plate 6, line insertion plate 7, line resilient contact arm 83, and neutral resilient contact arm 84 are respectively assembled with the core assembly 8. Preferably, an insertion plate stabilizer plate 43 is provided to help stabilize the insertion plates, where the neutral insertion plate 6 and line insertion plate 7 pass through the insertion plate stabilizer plate 43.

The trip assembly includes a trip frame 85, a trip actuator 81, a plunger 82 and a relay coil 87. The plunger 82 is disposed within the relay coil 87. When the relay coil 87 generates a magnetic field, the plunger 82 is actuated by the magnetic field and moves in a first direction along the internal channel of the relay coil 87. In conventional trip designs, a trip actuator cooperates with the plunger to move in a second direction perpendicular to the first direction, pushing the resilient contact arms to move so that the moveable contact terminals contact the stationary contact terminals, achieving the electrical connection. In embodiments of the present invention, however, the trip actuator 81 is designed to pivot around a pivotal support axis, which converts the movement of the plunger 82 in the first direction to a movement of the trip actuator 81 in the second direction which is non-parallel to (preferably, perpendicular to) the first direction. This design can effectively reduce the distance of travel of the trip actuator 81, which in turn reduces the size of the leakage current protection device and its cost.

More specifically, the plunger 82 and the trip actuator 81 are mechanically engaged with each other and move together with each other, such that: when the plunger 82 is not actuated and is located at a first position, the trip actuator 81 is in a first position so that the input and output ends are electrically disconnected; when the plunger 82 is actuated and moves linearly to a second position, it causes the trip actuator 81 to pivot around a pivotal support axis to a second position so that the input and output ends are electrically connected to each other.

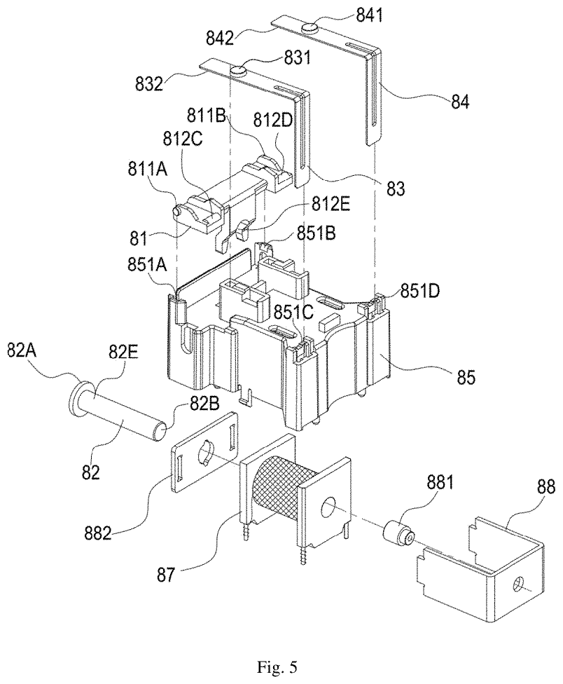

To achieve the above results, in some embodiments, the trip actuator 81 and the plunger 82 are engaged with each other by slots, where one of the trip actuator 81 and the plunger 82 has a slot and the other one has a corresponding portion that fits in the slot. In the embodiment shown in FIGS. 3 and 5, the trip actuator 81 has a slot 812E; the plunger 82 has a head 82A, an elongated shaft 82B that can be inserted into the relay coil 87, and a portion 82E located next to the head 82A. The head 82A is an outwardly extending flange, and that the portion 82E can fit into the slot 812E of the trip actuator 81 while the head 82A abuts the edge of the slot 812E. This way, when the plunger 82 moves in the first direction, it causes the slotted part of the trip actuator 81 to move with it in the first direction.

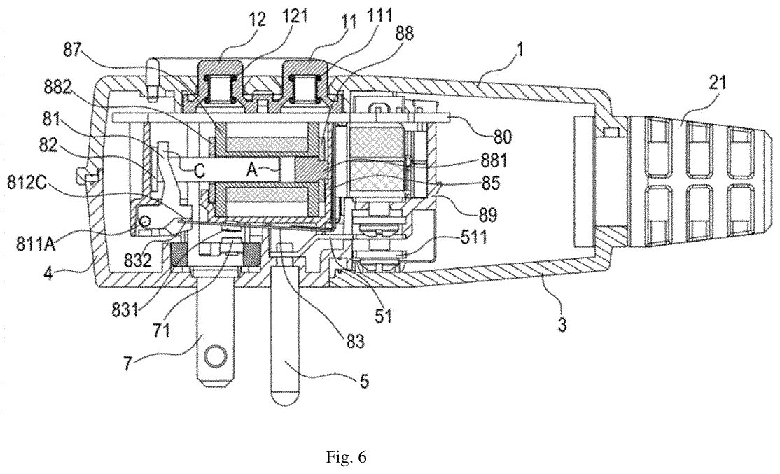

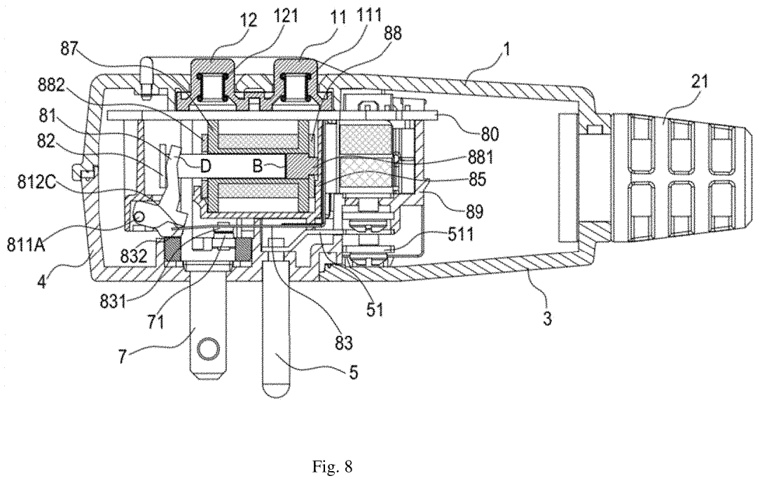

In some embodiments, the trip actuator 81 has pivotal support posts that allow the trip actuator 81 to pivot relative to the trip frame 85; correspondingly, the trip frame 85 has position limiting indentations that accommodate the pivotal support posts to allow the trip actuator 81 to pivot. It should be understood that, conversely, it is also possible to provide pivotal support posts on the trip frame 85 with corresponding position limiting indentations on the trip actuator 81 to accommodate the posts. In the embodiment shown in FIG. 5, the trip actuator 81 has two pivotal support posts 811A, 811B, which protrude respectively from the two ends of the trip actuator 81, and the trip frame 85 has two corresponding position limiting indentations 851A, 851B, at corresponding locations for accommodating the pivotal support posts 811A, 811B. These structures provide pivotal support for the trip actuator 81 to pivot. The trip actuator 81 may additionally have two bumps 812C, 812D as driving points, at locations corresponding to a point 832 of the line resilient contact arm 83 and a point 842 of the neutral resilient contact arm 84, respectively. Generally speaking, the trip actuator 81 is approximately an L shape in the cross-sectional view (e.g., FIGS. 6 and 8), where the pivotal support axis is located approximately at the elbow position of the L, the slotted end that engages with the plunger 82 is located approximately at the end of the first arm of the L, and the driving points 812C, 812D are located on the second arm of the L and face a direction approximately perpendicular to the second arm. As the trip actuator 81 pivots, this structure converts the movement of the slotted end which is perpendicular to the first arm to the movement of the driving points which is perpendicular to the second arm. Further, the trip frame 85 has two position limiting slots 851C, 851D, which respectively serve to limit the positions of the line resilient contact arm 83 and neutral resilient contact arm 84 which pass through the slots.

As shown in FIGS. 3 and 5, the trip assembly has a magnetically permeable device, which cooperates with the relay coil 87 that actuates the plunger 82 to improve the effectiveness of the magnetic field. In the illustrated embodiments, the magnetically permeable device includes a magnetic core 881, a magnetic frame 88 and a magnetic plate 882, where the magnetic core 881 is disposed inside the relay coil 87, and the magnetic frame 88 and a magnetic plate 882 are disposed around the relay coil 87, preferably pressing the relay coil 87 between them.

As shown in FIGS. 3 and 4, the core assembly further includes a detector assembly. The line resilient contact arm 83 and neutral resilient contact arm 84 are electrically connected to the output end via a wiring assembly that passes through the detector assembly. In the illustrated embodiment, the detector assembly includes a detector coil ring assembly 89. A line wiring terminal 891 and a neutral wiring terminal 892 pass through the detector ring assembly 89; one of their ends are respectively connected to the line resilient contact arm 83 and neutral resilient contact arm 84 via a line conductor plate 801 and a neutral conductor plate 802, and the other one of their ends are respectively connected to the output end, for example, to the output wires 2 via a line wiring screw assembly 8911 and a neutral wiring screw assembly 8912, respectively.

The operations of the leakage current protection device are described below with reference to FIGS. 6-10.

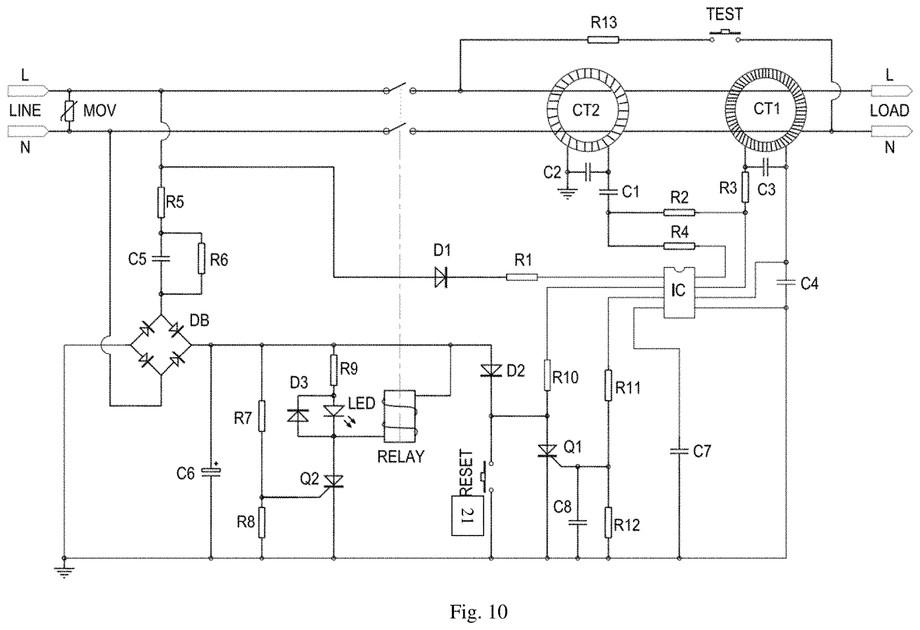

When the leakage current protection device is not connected to the external power source, the relay coil 87 (RELAY in FIG. 10) is not energized. As shown in FIG. 6, the proximal end of the plunger 82 is located at a first position A, and correspondingly, the slotted end of the trip actuator 81 (where the trip actuator 81 is engaged with the plunger 82) is located at a first position C; the leakage current protection device is in a first state where the input and output ends are electrically disconnected from each other. As shown in FIG. 10, when the input end LINE is connected to the external power source, the relay coil RELAY is energized to generate a magnetic field. Thus, as shown in FIG. 8, the plunger 82 moves toward the magnetic core 881 to a second position B, while pulling the slotted end of the trip actuator 81 to a second position D. The movement of the slotted end of the trip actuator 81 is realized by a pivoting of the trip actuator 81 around the axis of the pivotal support posts 811A, 811B, which causes the bumps 812C, 812D to move, which in turn pushes the point 832 of the line resilient contact arm 83 and the point 842 of the neutral resilient contact arm 84 to move. As a result, the line moveable contact terminal 831 on the line resilient contact arm 83 and the neutral moveable contact terminal 841 on the neutral resilient contact arm 84 respectively contact the line stationary contact terminal 71 on the line insertion plate 7 and the neutral stationary contact terminal 61 on the neutral insertion plate 6, so that the input and output ends are electrically connected.

As shown in FIG. 10, when the leakage current detection ring CT1 (the detector ring assembly 89) detects a leakage current, the integrated circuit IC generates a leakage fault signal to trigger the silicon controlled rectifier Q1 to become conductive. As a result, the relay coil RELAY is de-energized (i.e. no current flows through it), and the magnetic field disappears. Therefore, the resilient forces of the line resilient contact arm 83 and neutral resilient contact arm 84 push the bumps 812C, 812D of the trip actuator 81 to move, causing the trip actuator 81 to pivot around the pivotal support posts 811A, 811B so that its slotted end returns to the first position C shown in FIG. 6. As a result, the proximal end of the plunger 82 returns to the first position A (because there is no magnetic field to pull it). In this state, the line moveable contact terminal 831 on the line resilient contact arm 83 and the neutral moveable contact terminal 841 on the neutral resilient contact arm 84 are respectively disconnected from the line stationary contact terminal 71 on the line insertion plate 7 and the neutral stationary contact terminal 61 on the neutral insertion plate 6, so that the input and output ends are electrically disconnected.

Further, as described earlier, the reset conductor 121 and the test conductor 111 are respectively elastically embedded in the reset button 12 and the test button 11. As shown in FIG. 6, when no external force is pressing down on the reset button 12 and/or test button 11, due to the resilient forces of the reset button 12 and/or test button 11, the reset conductor 121 and/or test conductor 111 do not contact the control circuit board PCBA, so the reset switch RESET and/or the test switch TEST (see FIG. 10) are open. When an external force is pressing down on the reset button 12 or test button 11, the reset conductor 121 or test conductor 111 are lowered to contact the control circuit board PCBA, causing electrical connection of relevant wires on the control circuit board PCBA, so that the reset switch RESET or the test switch TEST (see FIG. 10) are close to perform the reset or test functions, respectively.

It should be understood that the embodiments shown in the drawings only illustrate the preferred shapes, sizes and spatial arrangements of the various components of the leakage current protection device. These illustrations do not limit the scope of the invention; other shapes, sizes and spatial arrangements may be used without departing from the spirit of the invention.

It will be apparent to those skilled in the art that various modification and variations can be made in the leakage current protection device of the present invention without departing from the spirit or scope of the invention. Thus, it is intended that the present invention cover modifications and variations that come within the scope of the appended claims and their equivalents.

What is claimed is:

1. A leakage current protection device, comprising:
a shell; and
a core assembly disposed within the shell, wherein the core assembly includes a control circuit board, a trip assembly disposed on the control circuit board, and an input end and an output end connected to the trip assembly;
wherein the trip assembly includes a first driving member movable linearly in a first direction and a second driving member pivotable around a pivotal support axis, wherein the first driving member and the second driving member are mechanically engaged with each other and move together with each other, wherein the second driving member has two driving points configured to move in a second direction as the second driving member pivots, the second direction being non-parallel to the first direction, and wherein movements of the two driving points of the second driving member in the second direction are operable to electrically connect or disconnect the input end and the output end.

2. The leakage current protection device of claim 1, wherein the trip assembly further includes a relay coil, wherein the first driving member is a plunger disposed inside the relay coil, and the second driving member is a trip actuator, wherein when the plunger is in its first position, the trip actuator is in its first position which electrically disconnects the input end and output end, and when the plunger is actuated by the relay coil and moves to its second position, the trip actuator moves accordingly to its second position which electrically connects the input end and output end.

3. The leakage current protection device of claim 2, wherein one of the trip actuator and the plunger has a slot and the other one of the trip actuator and the plunger has a corresponding portion that fits in the slot.

4. The leakage current protection device of claim 2, wherein the trip assembly further includes a magnetically permeable device configured to cooperate with the relay coil, the magnetically permeable device includes a magnetic core disposed inside the relay coil, a magnetic frame, and a magnetic plate, wherein the magnetic frame and the magnetic plate are disposed around the relay coil.

5. The leakage current protection device of claim 2, wherein the trip assembly further includes a trip frame, wherein the trip actuator has two pivotal support posts and the trip frame has two corresponding position limiting indentations configured to respectively accommodate the two pivotal support posts, wherein the trip actuator is pivotable around an axis defined by the two pivotal support posts.

6. The leakage current protection device of claim 5, wherein the input end includes a pair of insertion plates, each insertion plate including a stationary contact terminal, wherein the output end includes a pair of resilient contact arms, each resilient contact arm having a moveable contact terminal configured to cooperate with the corresponding stationary contact terminal, and wherein the two driving points of the trip actuator press the moveable contact terminals to contact the corresponding stationary contact terminals.

7. The leakage current protection device of claim 6, wherein the trip frame includes two position limiting slots, wherein the pair of resilient contact arms respectively pass through the two position limiting slots.

8. The leakage current protection device of claim 6, wherein the core assembly further includes a detector assembly, and a wiring assembly that passes through the detector assembly, wherein the pair of resilient contact arms are electrically connected to the output end via the wiring assembly.

9. The leakage current protection device of claim 2, further comprising:
a reset button and a reset conductor embedded in the reset button;
a test button and a test conductor embedded in the test button;
wherein the reset button and the test button protrude from the shell, and wherein the reset conductor is configured to contact the control circuit board in response to the reset button being depressed, and the test conductor is configured to contact the control circuit board in response to the test button being depressed.

10. The leakage current protection device of claim 9, wherein the reset button and the test button are formed of a flexible insulating material, and the reset conductor and the test conductor are elastically embedded in the reset button and the test button, respectively.

11. The leakage current protection device of claim 2, further comprising a cable strain relief connected to the shell and extends outside of the shell, and an affixing assembly configured to affix electrical output wires to the shell.
